(19) United States
(12) Patent Application Publication
(10) Pub. No.: US 2020/0196281 A1
(43) Pub. Date: Jun. 18, 2020

(54) RESOURCE ALLOCATION FOR BANDWIDTH LIMITED OPERATION

(71) Applicant: TELEFONAKTIEBOLAGET LM ERICSSON (PUBL), Stockholm (SE)

(72) Inventors: Johan Bergman, STOCKHOLM (SE); Hazhir Shokri Razaghi, SOLNA (SE)

(21) Appl. No.: 16/349,482

(22) PCT Filed: Nov. 14, 2017
(86) PCT No.: PCT/IB2017/057104

§ 371 Date: May 13, 2019

Related U.S. Application Data
(60) Provisional application No. 62/421,823, filed on Nov. 14, 2016.

(51) Int. Cl. H04W 72/04; H04W 4/70

(52) U.S. Cl. CPC H04W 72/042; H04W 84/042; H04W 4/70; H04W 72/048

(57) ABSTRACT

Systems and methods are disclosed herein for providing resource allocation for wide bandwidth wireless communication devices. In general, resource allocation is provided in a manner that enables efficient resource allocation for both wide bandwidth wireless communication devices and narrowband wireless communication devices.

### RELATED APPLICATIONS

This application claims the benefit of provisional patent application Ser. No. 62/421,823, filed Nov. 14, 2016, the disclosure of which is hereby incorporated herein by reference in its entirety.

### TECHNICAL FIELD

The disclosed subject matter relates generally to telecommunications. Certain embodiments relate more particularly to resource block assignment, resource allocation, or Machine Type Communication (MTC).

### BACKGROUND

In the Third Generation Partnership Project (3GPP), Radio Access Network (RAN) Radio Layer 1 (RAN1) [6] has agreed that Bandwidth-reduced Low-complexity (BL) and non-BL User Equipment devices (UEs) in Long Term Evolution (LTE) Release (Rel) 14 can operate using a wider bandwidth of 5 Megahertz (MHz) in Coverage Enhancement (CE) mode A and CE mode B for the downlink data channel (i.e., the Physical Downlink Shared Channel (PDSCH)) and in CE mode A for the uplink data channel (e.g., Physical Uplink Shared Channel (PUSCH)). In contrast, LTE Rel-13 UEs operate using a 1.4 MHz bandwidth equivalent to six Physical Resource Blocks (PRBs). Such 1.4 MHz portions of the total system bandwidth are referred to as narrowbands. These narrowbands do not overlap within the system bandwidth. Given that the Rel-13 and Rel-14 UEs need to coexist in the same cell, there is a need for systems and methods for resource allocation that manage different kinds of UEs in an efficient way by, e.g., providing proper sharing of the bandwidth to different UEs and exploiting the resources available in the whole bandwidth.

### SUMMARY

Systems and methods are disclosed herein for providing resource allocation for wide bandwidth wireless communication devices. In general, resource allocation is provided in a manner that enables efficient resource allocation for both wide bandwidth wireless communication devices and narrowband wireless communication devices.

In some embodiments, a method of operation of a wireless communication device operating in a wide bandwidth that is larger than a predefined narrowband bandwidth in a wireless communication system comprises receiving, from a network node, Downlink Control Information (DCI) comprising a resource block assignment. Five Least-Significant Bits (LSBs) of the resource block assignment are any one of a set of bit combinations, wherein the set of bit combinations consists of: {10101}, {10110}, {10111}, {11000}, {11001}, {11010}, {11011}, {11100}, {11101}, {11110}, and {11111}. The method further comprises utilizing the resource block assignment, wherein utilizing the resource block assignment comprises interpreting the resource block assignment such that the one of the set of bit combinations comprised in the five LSBs of the resource block assignment provides a resource allocation within the wide bandwidth.

In some embodiments, the five LSBs of the resource block assignment are one of a group consisting of: {10101}, {10110}, and {10111}.

In some embodiments, a system bandwidth of the wireless communication system is logically divided into a plurality of narrowband portions, the wide bandwidth in which the wireless communication device is operating is a subset of the plurality of narrowband portions, each narrowband portion of the subset of the plurality of narrowband portions within the wide bandwidth is logically divided into two physical resource block groups, and the resource allocation is a resource allocation for each of the two Physical Resource Block (PRB) groups in each of the subset of the plurality of narrowband portions within the wide bandwidth.

In some embodiments, interpreting the resource block assignment comprises interpreting the resource block assignment such that a number of Most-Significant Bits (MSBs) of the resource block assignment provide a starting narrowband index for the wide bandwidth. Further, in some embodiments, a system bandwidth of the wireless communication system is logically divided into a plurality of narrowband portions each of the predefined narrowband bandwidth, and the starting narrowband index indicates one of the plurality of narrowband portions that is a starting narrowband portion for the wide bandwidth in which the wireless communication device is operating. In some embodiments, the number of MSBs interpreted to provide the starting narrowband index for the wide bandwidth is defined as:

$$StartingNarrowbandIndexSize = ⌈ {log}_{2} ⌊ \frac{{N}_{RB}^{DL}}{6} ⌋ ⌉ ,$$

where StartingNarrowbandIndexSize is the number of MSBs interpreted to provide the starting narrowband index for the wide bandwidth and N_{RB}^{DL} is the system bandwidth represented as a number of resource blocks.

In some embodiments, the wireless communication system is a Long Term Evolution (LTE) system, and the set of bit combinations is a plurality of bit combinations that are unused for DCI format 6-A1 type 2 resource allocation.

In some embodiments, each of the set of bit combinations has a predefined mapping to a different resource allocation for the wide bandwidth.

In some embodiments, the wide bandwidth is 5 megahertz (MHz), and the predefined narrowband bandwidth is 1.4 MHz.

Embodiments of a wireless communication device are also disclosed. In some embodiments, a wireless communication device for operating in a wide bandwidth that is larger than a predefined narrowband bandwidth in a wireless communication system is adapted to receive, from a network node, DCI comprising a resource block assignment, wherein five LSBs of the resource block assignment are any one of a set of bit combinations and the set of bit combinations consists of: {10101}, {10110}, {10111}, {11000}, {11001}, {11010}, {11011}, {11100}, {11101}, {11110}, and {11111}. The wireless device is further adapted to utilize the resource block assignment, where utilizing the resource block assignment comprises interpreting the resource block assignment such that the one of the set of bit combinations comprised in the five LSBs of the resource block assignment provides a resource allocation within the wide bandwidth.

In some embodiments, a wireless communication device for operating in a wide bandwidth that is larger than a predefined narrowband bandwidth in a wireless communication system comprises a transceiver, a processor, and memory comprising instructions executable by the processor whereby the wireless communication device is operable to receive, from a network node, DCI comprising a resource block assignment, wherein five LSBs of the resource block assignment are any one of a set of bit combinations and the set of bit combinations consists of: {10101}, {10110}, {10111}, {11000}, {11001}, {11010}, {11011}, {11100}, {11101}, {11110}, and {11111}. The wireless communication device is further operable to utilize the resource block assignment, where utilizing the resource block assignment comprises interpreting the resource block assignment such that the one of the set of bit combinations comprised in the five LSBs of the resource block assignment provides a resource allocation within the wide bandwidth.

In some embodiments, a wireless communication device for operating in a wide bandwidth that is larger than a predefined narrowband bandwidth in a wireless communication system comprising a receiving module and a utilizing module. The receiving module is operable to receive, from a network node, DCI comprising a resource block assignment, wherein five LSBs of the resource block assignment are any one of a set of bit combinations and the set of bit combinations consists of: {10101}, {10110}, {10111}, {11000}, {11001}, {11010}, {11011}, {11100}, {11101}, {11110}, and {11111}. The utilizing module is operable to utilize the resource block assignment, where utilizing the resource block assignment comprises interpreting the resource block assignment such that the one of the set of bit combinations comprised in the five LSBs of the resource block assignment provides a resource allocation within the wide bandwidth.

In some embodiments, a method of operation of a wireless communication device in a wide bandwidth that is larger than a predefined narrowband bandwidth in a wireless communication system comprises receiving, from a network node, DCI comprising a resource block assignment, the resource block assignment comprising a number of bits that is equal to:

$$⌈ {log}_{2} ⌊ \frac{{N}_{RB}^{DL}}{6} ⌋ ⌉ + 1$$

where N_{RB}^{DL} is a system bandwidth represented as a number of resource blocks and a LSB of the resource block assignment is set to “0” such that the resource block assignment is indicated as being for a wireless communication device with an operating bandwidth that is larger than the predefined narrowband bandwidth. The method further comprises utilizing the resource block assignment, where utilizing the resource block assignment comprises interpreting the resource block assignment as a resource block assignment for the wide bandwidth as a result of the LSB of the resource block assignment being set to “0”.

In some embodiments, the system bandwidth is divided into a plurality of wide bandwidth regions each comprising two or more resource block groups, and the resource block assignment indicates one of the plurality of wide bandwidth regions and a resource allocation for each of the two or more resource block groups within the one of the plurality of wide bandwidth regions.

In some embodiments, the wireless communication system is a LTE system, and the DCI is provided in accordance with DCI format 6-1B.

In some embodiments, the wide bandwidth is 5 MHz, and the predefined narrowband bandwidth is 1.4 MHz.

In some embodiments, a wireless communication device for operating in a wide bandwidth that is larger than a predefined narrowband bandwidth in a wireless communication system is adapted to receive, from a network node, DCI comprising a resource block assignment, the resource block assignment comprising a number of bits that is equal to:

$$⌈ {log}_{2} ⌊ \frac{{N}_{RB}^{DL}}{6} ⌋ ⌉$$

where N_{RB}^{DL} is a system bandwidth represented as a number of resource blocks and a LSB of the resource block assignment is set to “0” such that the resource block assignment is indicated as being for a wireless communication device with an operating bandwidth that is larger than the predefined narrowband bandwidth. The wireless communication device is further adapted to utilize the resource block assignment, where utilizing the resource block assignment comprises interpreting the resource block assignment as a resource block assignment for the wide bandwidth as a result of the LSB of the resource block assignment being set to “0”.

In some embodiments, a wireless communication device for operating in a wide bandwidth that is larger than a predefined narrowband bandwidth in a wireless communication system comprises a transceiver, a processor, and memory comprising instructions executable by the processor whereby the wireless communication device is operable to receive, from a network node, DCI comprising a resource block assignment, the resource block assignment comprising a number of bits that is equal to:

$$⌈ {log}_{2} ⌊ \frac{{N}_{RB}^{DL}}{6} ⌋ ⌉$$

where N_{RB}^{DL} is a system bandwidth represented as a number of resource blocks and a LSB of the resource block assignment is set to “0” such that the resource block assignment is indicated as being for a wireless communication device with an operating bandwidth that is larger than the predefined narrowband bandwidth. The wireless communication device is further operable to utilize the resource block assignment, where utilizing the resource block assignment comprises interpreting the resource block assignment as a resource block assignment for the wide bandwidth as a result of the LSB of the resource block assignment being set to “0”.

In some embodiments, a wireless communication device for operating in a wide bandwidth that is larger than a predefined narrowband bandwidth in a wireless communication system comprises a receiving module and a utilizing module. The receiving module is operable to receive, from a network node, DCI comprising a resource block assignment, the resource block assignment comprising a number of bits that is equal to:

$$⌈ {log}_{2} ⌊ \frac{{N}_{RB}^{DL}}{6} ⌋ ⌉$$

where N_{RB}^{DL} is a system bandwidth represented as a number of resource blocks and a LSB of the resource block assignment is set to “0” such that the resource block assignment is indicated as being for a wireless communication device with an operating bandwidth that is larger than the predefined narrowband bandwidth. The utilizing module is operable to utilize the resource block assignment, where utilizing the resource block assignment comprises interpreting the resource block assignment as a resource block assignment for the wide bandwidth as a result of the LSB of the resource block assignment being set to “0”.

In some embodiments, a method of operation of a radio access node in a wireless communication system comprises transmitting, to a wireless communication device operating in a wide bandwidth that is larger than a predefined narrowband bandwidth, DCI comprising a resource block assignment, wherein five LSBs of the resource block assignment are any one of a set of bit combinations and the set of bit combinations consists of: {10101}, {10110}, {10111}, {11000}, {11001}, {11010}, {11011}, {11100}, {11101}, {11110}, and {11111}.

In some embodiments, the five LSBs of the resource block assignment are one of a group consisting of: {10101}, {10110}, and {10111}.

In some embodiments, the wide bandwidth is 5 MHz, and the predefined narrowband bandwidth is 1.4 MHz.

In some embodiments, a radio access node for a wireless communication system is adapted to transmit, to a wireless communication device operating in a wide bandwidth that is larger than a predefined narrowband bandwidth, DCI comprising a resource block assignment, wherein five LSBs of the resource block assignment are any one of a set of bit combinations and the set of bit combinations consists of: {10101}, {10110}, {10111}, {11000}, {11001}, {11010}, {11011}, {11100}, {11101}, {11110}, and {11111}.

In some embodiments, the five LSBs of the resource block assignment are one of a group consisting of: {10101}, {10110}, and {10111}.

In some embodiments, the wide bandwidth is 5 MHz, and the predefined narrowband bandwidth is 1.4 MHz.

In some embodiments, a radio access node for a wireless communication system comprises a transceiver, a processor, and memory comprising instructions executable by the processor whereby the radio access node is operable to transmit, to a wireless communication device operating in a wide bandwidth that is larger than a predefined narrowband bandwidth, DCI comprising a resource block assignment, wherein five LSBs of the resource block assignment are any one of a set of bit combinations and the set of bit combinations consists of: {10101}, {10110}, {10111}, {11000}, {11001}, {11010}, {11011}, {11100}, {11101}, {11110}, and {11111}.

In some embodiments, a radio access node for a wireless communication system comprises a transmitting module operable to transmit, to a wireless communication device operating in a wide bandwidth that is larger than a predefined narrowband bandwidth, DCI comprising a resource block assignment, wherein five LSBs of the resource block assignment are any one of a set of bit combinations and the set of bit combinations consists of: {10101}, {10110}, {10111}, {11000}, {11001}, {11010}, {11011}, {11100}, {11101}, {11110}, and {11111}.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows resource allocation according to some embodiments of the present disclosure;

FIG. 2 illustrates one example of a communication system in which embodiments of the present disclosure may be implemented;

FIG. 3 illustrates the operation of a network node and a wireless communication device in accordance with some embodiments of the present disclosure;

FIG. 4 illustrates the operation of a network node and a wireless communication device in accordance with some other embodiments of the present disclosure;

FIG. 5 illustrates a wireless communication device according to an embodiment of the disclosed subject matter;

FIG. 6 illustrates a wireless communication device according to another embodiment of the disclosed subject matter;

FIG. 7 illustrates a radio access node according to an embodiment of the disclosed subject matter;

FIG. 8 illustrates a radio access node according to another embodiment of the disclosed subject matter; and

FIG. 9 illustrates a radio access node according to yet another embodiment of the disclosed subject matter.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the disclosed subject matter.

Certain embodiments are presented in recognition of shortcomings associated with conventional technologies, such as the following.

Radio Access Network (RAN) Radio Layer 1 (RAN1) [6] has agreed that Bandwidth-reduced Low-complexity (BL) and non-BL User Equipment devices (UEs) in Long Term Evolution (LTE) Release (Rel) 14 can operate using a wider bandwidth of 5 Megahertz (MHz) in Coverage Enhancement (CE) mode A and CE mode B for downlink data channel (i.e., the Physical Downlink Shared Channel (PDSCH)) and in CE mode A for uplink data channels (e.g., Physical Uplink Shared Channel (PUSCH)). In contrast, LTE Rel-13 UEs operate using a 1.4 MHz bandwidth equivalent to six Physical Resource Blocks (PRBs). Such 1.4 MHz portions of the total system bandwidth are referred to as narrowbands. These narrowbands do not overlap within the system bandwidth. Given that the Rel-13 and Rel-14 UEs need to coexist in the same cell, it is important to devise a resource allocation method that manages different kinds of UEs in an efficient way by, e.g., providing proper sharing of the bandwidth to different UEs and exploiting the resources available in the whole bandwidth.

It is also agreed that the Machine Type Communication (MTC) Physical Downlink Control Channel (PDCCH) (MPDCCH) design for Rel-14 UEs follows the Rel-13 design, which implies that the MPDCCH can be decoded by a UE operating in narrowband operation (i.e., operating in a bandwidth of six PRBs). This means that the new resource allocation for the data channels in higher bandwidth operation should be flexible enough so as to incorporate the MPDCCH allocation of size six PRBs while minimizing restriction on resource allocation of Rel-13 UEs as well as Rel-14 UEs.

Based on the above agreements, it is also desired that, due to backward compatibility, the resource allocation field within the Downlink Control Information (DCI) can be interpreted by Rel-14 UEs the same way as is done by Rel-13 UEs. This is beneficial because, if Rel-14 UEs are scheduled with the same data bandwidth as Rel-13 UEs, both types of UEs can be allocated within a narrowband without placing any limitations on one another.

Furthermore, it is agreed that if a new grant is introduced for wideband PDSCH/PUSCH, the number of Blind Decodings (BDs) of MPDCCH does not increase with respect to Rel-13 enhanced MTC (eMTC). In order to keep the number of BDs at the same level, it is desired to keep the size of the Rel-14 DCI the same as that in Rel-13.

Certain embodiments of the present disclosure provide approaches for resource allocation of UEs operating in a bandwidth that is larger than a six PRB narrowband, which requires support for allocation within the six PRB bandwidth at the same time.

Certain embodiments relate to LTE (Further Enhancements for MTC (FeMTC)) but may also be applicable for other technologies such as, e.g., Narrowband Internet of Things (NB-IoT) and Fifth Generation (5G) New Radio (NR).

Certain embodiments may provide various potential benefits compared to conventional technologies, such as the following. First, certain embodiments provide an efficient resource allocation method for UEs with higher bandwidth keeping the MPDCCH DCI size the same. Second, certain embodiments keep backward compatibility of the resource allocation method such that existing UEs and UEs with new higher bandwidth capability can coexist efficiently. Third, certain embodiments provide enough flexibility to manage simultaneous resource allocation of UEs with different allocated number of resource blocks.

Systems and methods are disclosed herein for resource allocation of UEs operating in bandwidths larger than a narrowband (e.g., six PRBs). At the same time, systems and methods disclosed herein keep the capability of resource allocation inside one narrowband.

According to some embodiments of the present disclosure, some of the bitmap combinations in a resource block assignment field in DCI are reinterpreted for UEs operating in bandwidth larger than a narrowband. These reinterpreted bitmaps are used to perform resource assignments of larger allocation than a narrowband or six PRBs.

In some embodiments, the UE will use a resource block assignment in a DCI format for PDSCH resource assignment that is based on the resource block assignment in the DCI format for PDSCH resource assignment for BL or non-BL UEs operating in CE mode A defined in Rel-13, i.e. DCI format 6-1A, defined in section 5.3.3.1.12 in [3], with one or more of the following modifications:
The

$$⌈ {log}_{2} ⌊ \frac{{N}_{RB}^{DL}}{6} ⌋ ⌉$$

Most-Significant Bits (MSBs) provide the first narrowband index that is encompassed inside the bandwidth of the UEs. The index indication is according to the definition of Rel-13 UEs indicated in section 6.2.7 of [2]. Note that narrowband definitions are according to the Rel-13 part of specifications.
Some limited number of bitmap combinations of five Least-Significant Bits (LSBs) in Rel-13 provide the resource allocation using downlink resource allocation type 2 within the indicated narrowband. The other bitmap combinations remain unused. These unused combinations are used for resource allocation of UEs that are assigned bandwidths with larger sizes than one narrowband (e.g., Rel-14 UEs operating in 5 MHz).
In DCI 6-A1 type 2, resource allocation is used for resource block allocation within a narrowband [2]. There are only 21 combinations required for indication of type 2 resource allocation within a narrowband. However, a bitmap of size 5 can provide 32 different combinations. Thus, the 32−21=11 remaining bit combinations can be used for resource block assignment for UEs with a larger operating bandwidth than a narrowband.
   Each of the unused bit combinations of the resource block assignment field in the DCI are then used to indicate one possible resource block assignment for UEs with a bandwidth larger than a narrowband.
The resource assignment within the bandwidth of the UE is done according to Rel-8 resource block assignment method type 0 with the following possible modifications:
   The total number of allocated PRBs is aligned with the definition of the narrowbands encompassed by UE bandwidth. For example, when a UE is operating in 5 MHz, the 5 MHz bandwidth of the UE can encompass up to four narrowbands.
   Total frequency resources are grouped into “n” consecutive PRBs (known as Resource Block Groups (RBGs)) starting from the first PRB in the first narrowband. They are numbered, or indexed, starting from the first PRB in the first narrowband. The PRBs within a RBG are assigned together.
Next, some of different combinations of possible resource block assignments are predefined using type 0 assignment. The number of different predefined combinations is equal to (or less than) the number of unused bit combinations in the resource allocation block field in the DCI, as discussed above.
Then, the UE will be informed of each of these predefined resource block assignments by sending one of the Rel-13 unused bitmaps in the resource block field of the DCI.

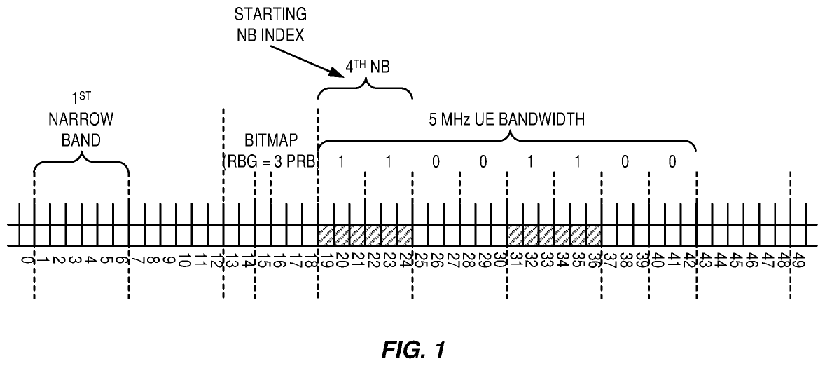

FIG. 1 shows resource allocation according to the first embodiment, using a bitmap example in Table 1 below. In particular, FIG. 1 illustrates resource allocation according to the first embodiment for the UEs in CE mode A, where the bitmap in the illustrated example is according to the “11010” indication bitmap in DCI in Table 1. In the example of FIG. 1, the total bandwidth (i.e., the system bandwidth) is 10 MHz, and the total bandwidth contains eight narrowbands. In other words, the total bandwidth is logically divided into a number of narrowbands (also referred to herein as narrowband portions). In this particular example, the total bandwidth is 10 MHz, and there are eight narrowband portions. As illustrated, in this example, each narrowband includes two Physical Resource Block Groups (PRGs), where each PRG has a PRG size equal to three PRBs.

Table 1 shows an example of resource block assignment using the embodiment described above in which previously unused resource block assignment bitmaps of Rel-13 UEs are used to indicate the resource block assignment of larger bandwidth UEs. It should be noticed that this is only one possible assignment of RBGs and other possible assignments can be obtained by changing the value of indication bits for each RBG index in the table.

TABLE 1
Resource block assignment for UEs with 5 MHz bandwidth (24
allocated PRBs) using bitmaps value in resource block assignment
filed in DCI which is not used in release 13

| | UE bandwidth (24 PRBs) in terms of RBGs | | | | | | | |
|---|---|---|---|---|---|---|---|---|
| Resource | (RBG = 3 PRBs) | | | | | | | |
| block | Allocated PRG indicated by 0/1 for each | | | | | | | |
| assignment | the bitmaps in the first column | | | | | | | |
| bitmap in DCI | NB #1 | | NB #2 | | NB #3 | | NB #4 | |
| (not used in | RBG | RBG | RBG | RBG | RBG | RBG | RBG | RBG |
| rel. 13) | #1 | #2 | #3 | #4 | #5 | #6 | #7 | #8 |
| 11000 | 1 | 1 | 1 | 0 | 0 | 0 | 0 | 0 |
| 11001 | 1 | 1 | 1 | 1 | 0 | 0 | 0 | 0 |
| 11010 | 1 | 1 | 0 | 0 | 1 | 1 | 0 | 0 |
| 11011 | 1 | 1 | 0 | 0 | 0 | 0 | 1 | 1 |
| 11100 | 1 | 1 | 1 | 1 | 1 | 1 | 0 | 0 |
| 11101 | 1 | 1 | 0 | 0 | 1 | 1 | 1 | 1 |
| 11110 | 1 | 1 | 1 | 1 | 0 | 0 | 1 | 1 |
| 11111 | 1 | 1 | 1 | 1 | 1 | 1 | 1 | 1 |

In the example of FIG. 1, a larger bandwidth that is equal to 24 PRBs is allocated to the UE. This larger bandwidth is equivalent to four narrowbands. The total system bandwidth is split into RBGs, each having a size of three PRBs. The narrowbands within the total system bandwidth are indexed from the first narrowband.

The first

$$⌈ {log}_{2} ⌊ \frac{{N}_{RB}^{DL}}{6} ⌋ ⌉$$

MSBs of the resource block assignment are used to indicate the index of NB #1 (i.e., a starting narrowband portion of the larger operating bandwidth of the UE) within the total system bandwidth. For example, if the total system bandwidth is 10 MHz, which contains eight narrowbands, the first

$$⌈ {log}_{2} ⌊ \frac{{N}_{RB}^{DL}}{6} ⌋ ⌉$$

MSBs of the resource block assignment indicates one of the values of 1 to 8 (or 0 to 7 if index starts from 0), where this value is the index of the starting narrowband portion of the larger operating bandwidth of the UE for which the resource allocation is provided. Note that this is not shown in Table 1.

In the example of FIG. 1, each narrowband is divided to two RBGs, and the narrowbands are aligned with the definition of Rel-13 narrowbands. This gives the enhanced or evolved Node B (eNB) enough flexibility to allocate resources to Rel-14 UEs aligned with the Rel-13 narrowband structure. The narrowbands are used for allocation of the data and control channel of Rel-13 UEs data as well as for allocation of Rel-14 MPDCCH.

In Table 1, whether each RBG is allocated or not is indicated by 1 or 0, respectively.

In the example of Table 1, only eight out of all eleven unused bitmap combinations of Rel-13 are used for resource assignment. In these combinations, the first two MSBs are “1,” which simplifies the algorithm implementation. However, all eleven combinations can be used, and more possible allocations up to eleven allocations can be added in the table.

In some other embodiments, the UE will use a resource block assignment in a DCI format for PDSCH resource assignment that is based on the resource block assignment in the DCI format for PDSCH resource assignment for BL or non-BL UEs operating in CE mode B defined in Rel-13, i.e. DCI format 6-1B, defined in section 5.3.3.1.13 in [3], with one or more of the following modifications:
There are overall

$$⌈ {log}_{2} ⌊ \frac{{N}_{RB}^{DL}}{6} ⌋ ⌉ + 1 bits$$

for PDSCH as defined for Rel-13 resource allocation, where the LSB with value 0 indicates resource blocks with PRB index {0, 1, 2, 3} and value 1 indicates that all six PRBs are used in Rel-13.
When the LSB equals 1, the interpretation of bitmaps of the resource block assignment in the DCI field remains the same and is used for allocation for UEs scheduled with one PRB (i.e., with a narrowband).
When the LSB equals 0, the resource block assignment field in the DCI is used for resource block assignment of UEs with larger bandwidth than one narrowband, e.g., Rel-14 MTC UEs. This could be done with different allocation methods.
   One way to interpret the bitmap when the LSB is equal to 0 for UEs operating in larger bandwidths than one narrowband, e.g., for Rel-14 UEs operating in 5 MHz bandwidths, is as follows: first divide the overall system bandwidth into non-overlapping 5 MHz wideband regions and then use RBG division in each region (as explained in the first embodiment). Then, each bitmap indicates the wideband along with the RBG allocation inside the wide band.

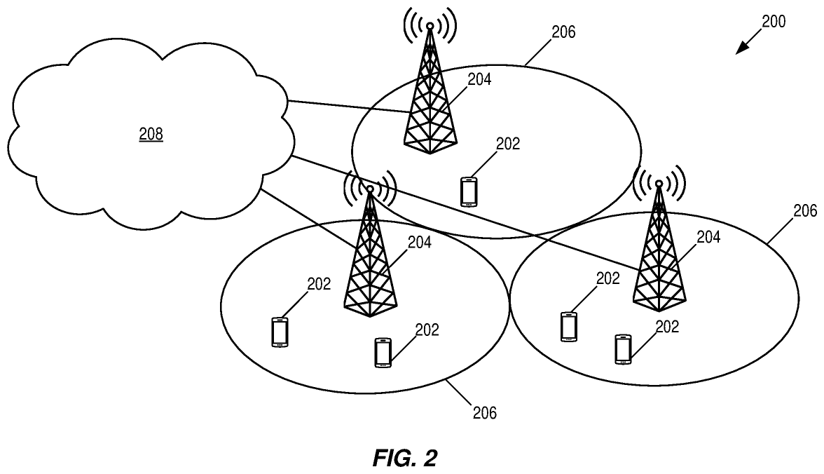

The described embodiments may be implemented in any appropriate type of communication system supporting any suitable communication standards and using any suitable components. As one example, certain embodiments may be implemented in a communication system such as that illustrated in FIG. 2. Although certain embodiments are described with respect to LTE systems and related terminology, the disclosed concepts are not limited to LTE or a Third Generation Partnership Project (3GPP) system. Additionally, although reference may be made to the term “cell,” the described concepts may also apply in other contexts, such as beams used in 5G systems, for instance.

Referring to FIG. 2, a communication system 200 comprises a plurality of wireless communication devices 202 (e.g., UEs, MTC/Machine-to-Machine (M2M) UEs) and a plurality of radio access nodes 204 (e.g., eNBs or other base stations). The communication system 200 is organized into cells 206, which are connected to a core network 208 via the corresponding radio access nodes 204. The radio access nodes 204 are capable of communicating with the wireless communication devices 202 along with any additional elements suitable to support communication between wireless communication devices or between a wireless communication device and another communication device (such as a landline telephone).

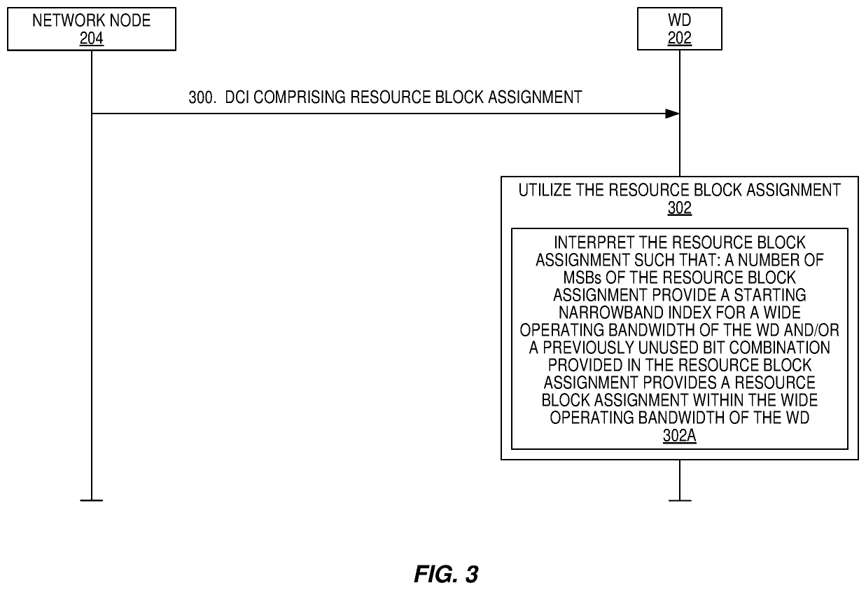

FIG. 3 illustrates the operation of a network node (e.g., a radio access node 204) and a wireless communication device 202 in accordance with some of the embodiments described herein. As illustrated, the network node 204 sends DCI to the wireless communication device 202 (step 300). As described above, the DCI includes a resource block assignment. In particular, in some embodiments, the wireless communication device 202 has a wide operating bandwidth (e.g., 5 MHz), and the resource block assignment is a resource block assignment that is to be interpreted by the wireless communication device 202 as a resource block assignment for a wide bandwidth wireless communication device 202. For instance, as discussed above, the resource block assignment includes a previously unused bit combination (e.g., a bit combination that is unused by narrowband wireless communication devices such as, e.g., those operating with a six PRB bandwidth).

The wireless communication device 202 utilizes the resource block assignment (step 302). In particular, the wireless communication device 202 interprets the resource block assignment as a resource block assignment for a wide bandwidth wireless communication device. As discussed above, the number of bits included in the resource block assignment is preferably the same as that used for narrowband wireless devices. However, those bits are interpreted differently for a resource block assignment for a wide bandwidth wireless device, such as the wireless communication device 202. As discussed above, in some embodiments in order to utilize the resource block assignment, the wireless communication device 202 interprets the resource block assignment such that: (a) a number of MSBs of the resource block assignment provide the starting narrowband index for the wide operating bandwidth of the wireless communication device 202 and/or (b) a previously unused bit combination provided in the resource block assignment provides a resource block assignment within the wide operating bandwidth of the wireless communication device 202 (step 302A).

In some embodiments, the resource block assignment comprises a bitmap of size 5 (i.e., a 5-bit bitmap), where 21 of the bit combinations are used for resource block assignment for narrowband wireless devices (e.g., Rel-13 UEs) and the remaining 11 bit combinations that are unused for resource block assignment for narrowband wireless devices are all used for resource block assignment for wide bandwidth wireless devices (e.g., Rel-14 UEs). This set of 11 bit combinations consists of: {10101}, {10110}, {10111}, {11000}, {11001}, {11010}, {11011}, {11100}, {11101}, {11110}, and {11111}. The resource block assignment provided by the network node 204 and received by the wireless communication device 202 is any one of this set of 11 bit combinations.

Further details regarding the resource block assignment and the interpretation of the resource block assignment are provided above and, therefore, are not repeated here with respect to FIG. 3. However, it is to be understood that those other aspects are equally applicable to FIG. 3.

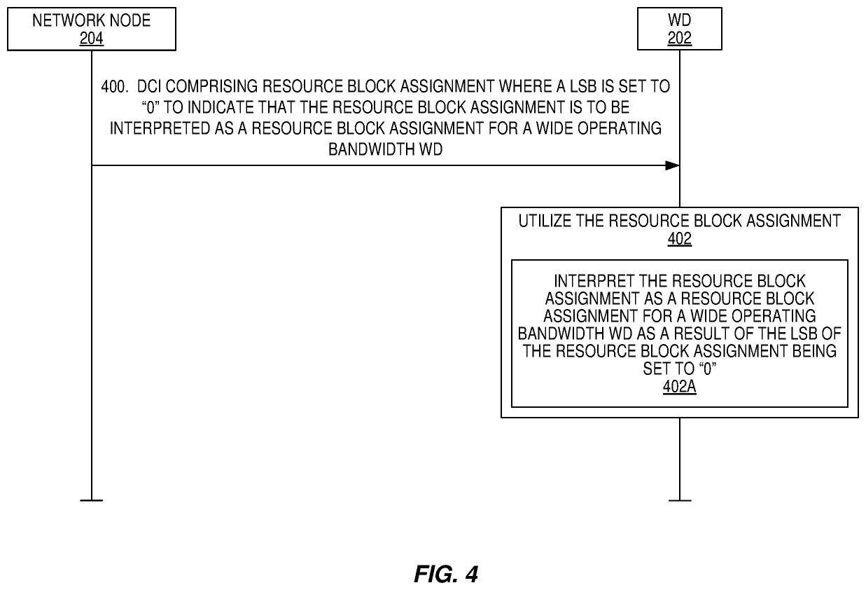

FIG. 4 illustrates the operation of a network node (e.g., a radio access node 204) and a wireless communication device 202 in accordance with some other embodiments described herein. As illustrated, the network node 204 sends DCI to the wireless communication device 202 (step 400). As described above, the DCI includes a resource block assignment. In particular, in some embodiments, the wireless communication device 202 has a wide operating bandwidth (e.g., 5 MHz), and the resource block assignment is a resource block assignment that is to be interpreted by the wireless communication device 202 as a resource block assignment for a wide bandwidth wireless communication device 202. For instance, in this embodiment, a LSB of the resource block assignment is set to “0” to indicate that the resource block assignment is to be interpreted as a resource block assignment for a wide operating bandwidth wireless communication device, which in this case is the wireless communication device 202.

The wireless communication device 202 utilizes the resource block assignment (step 402). In particular, the wireless communication device 202 interprets the resource block assignment as a resource block assignment for a wide bandwidth wireless communication device as a result of the LSB of the resource block assignment being set to “0”. As discussed above, in some embodiments in order to utilize the resource block assignment, the wireless communication device 202 interprets the resource block assignment as a resource block assignment for a wide operating bandwidth of the wireless communication device 202 as a result of the LSB of the resource block assignment being set to “0” (step 402A). Further details regarding the resource block assignment and the interpretation of the resource block assignment are provided above and, therefore, are not repeated here with respect to FIG. 4. However, it is to be understood that those other aspects are equally applicable to FIG. 4.

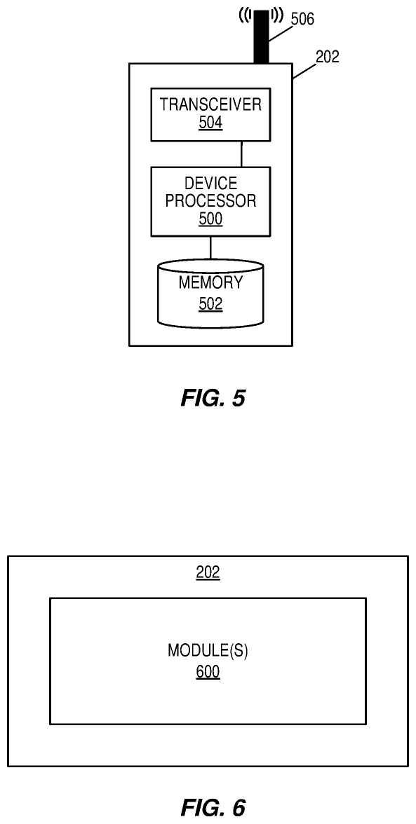

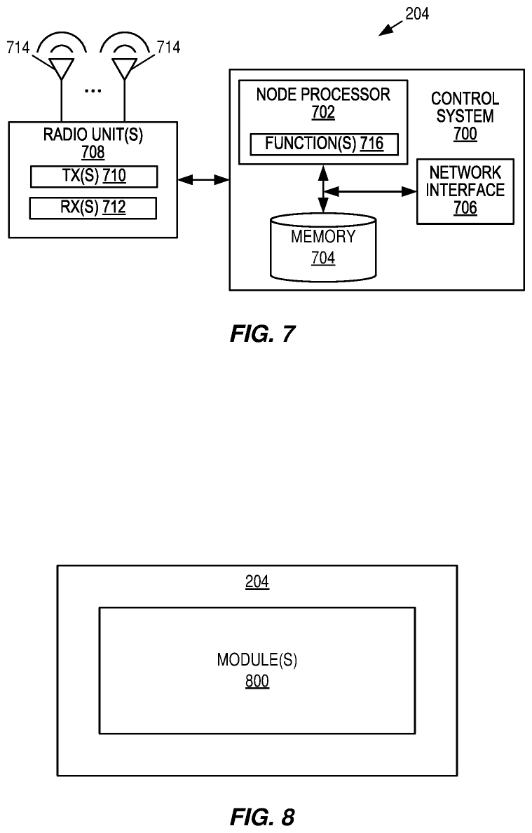

Although wireless communication devices 202 may represent communication devices that include any suitable combination of hardware and/or software, these wireless communication devices may, in certain embodiments, represent devices such as those illustrated in greater detail by FIGS. 5 and 6. Similarly, although the illustrated radio access node 204 may represent network nodes that include any suitable combination of hardware and/or software, these nodes may, in particular embodiments, represent devices such as those illustrated in greater detail by FIGS. 7, 8, and 9.

Referring to FIG. 5, a wireless communication device 202 comprises a processor 500 (e.g., Central Processing Units (CPUs), Application Specific Integrated Circuits (ASICs), Field Programmable Gate Arrays (FPGAs), and/or the like), a memory 502, a transceiver 504, and an antenna 506. In certain embodiments, some or all of the functionality described as being provided by UEs, MTC, or M2M devices, and/or any other types of wireless communication devices may be provided by the device processor 500 executing instructions stored on a computer-readable medium, such as the memory 502. Alternative embodiments may include additional components beyond those shown in FIG. 5 that may be responsible for providing certain aspects of the device's functionality, including any of the functionality described herein.

Referring to FIG. 6, a wireless communication device 202 comprises at least one module 600 configured to perform one or more corresponding functions. Examples of such functions include various method steps or combinations of method steps as described herein with reference to wireless communication device(s). In general, a module may comprise any suitable combination of software and/or hardware configured to perform the corresponding function. For instance, in some embodiments a module comprises software configured to perform a corresponding function when executed on an associated platform, such as that illustrated in FIG. 5.

Referring to FIG. 7, a radio access node 204 comprises a control system 700 that comprises a node processor 702 (e.g., CPUs, ASICs, FPGAs, and/or the like), memory 704, and a network interface 706. In addition, the radio access node 204 comprises at least one radio unit 708 comprising at least one transmitter 710 and at least one receiver 712 coupled to at least one antenna 714. In some embodiments, the radio unit 708 is external to the control system 700 and connected to the control system 700 via, e.g., a wired connection (e.g., an optical cable). However, in some other embodiments, the radio unit 708 and potentially the antenna(s) 714 are integrated together with the control system 700. The node processor 702 operates to provide at least one function 716 of the radio access node 204 as described herein. In some embodiments, the function(s) 716 are implemented in software that is stored, e.g., in the memory 704 and executed by the node processor 702.

In certain embodiments, some or all of the functionality described as being provided by a base station, a node B, an eNB, and/or any other type of network node may be provided by the node processor 702 executing instructions stored on a computer-readable medium, such as the memory 704 shown in FIG. 7. Alternative embodiments of the radio access node 204 may comprise additional components to provide additional functionality, such as the functionality described herein and/or related supporting functionality.

Referring to FIG. 8, a radio access node 204 comprises at least one module 800 configured to perform one or more corresponding functions. Examples of such functions include various method steps or combinations of method steps as described herein with reference to radio access node(s). In general, a module may comprise any suitable combination of software and/or hardware configured to perform the corresponding function. For instance, in some embodiments a module comprises software configured to perform a corresponding function when executed on an associated platform, such as that illustrated in FIG. 7.

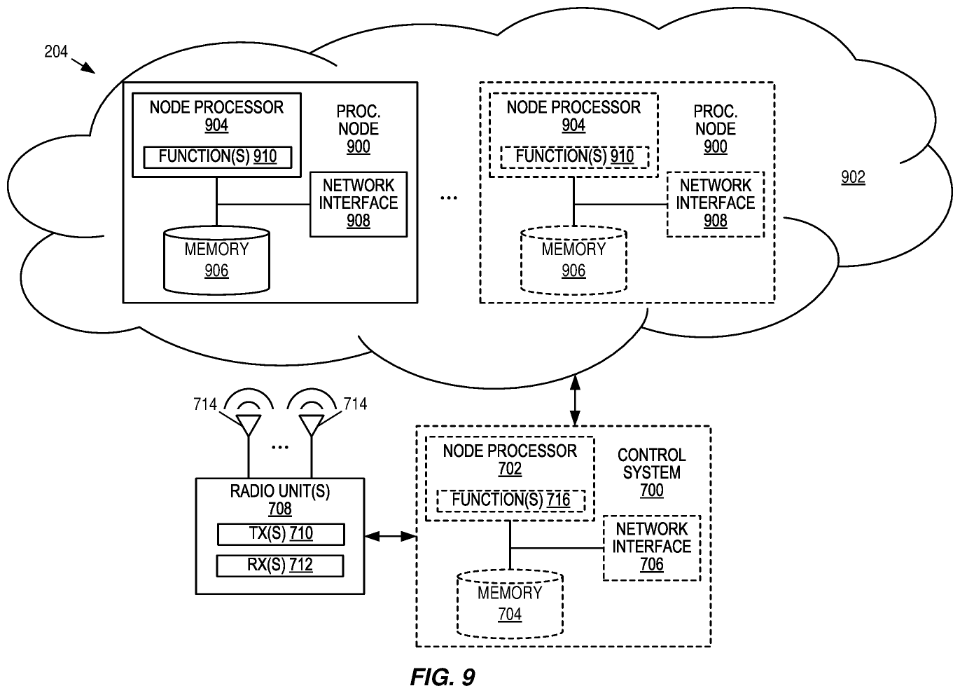

FIG. 9 is a block diagram that illustrates a virtualized radio access node 204 according to an embodiment of the disclosed subject matter. The concepts described in relation to FIG. 9 may be similarly applied to other types of network nodes. Further, other types of network nodes may have similar virtualized architectures. As used herein, the term “virtualized radio access node” refers to an implementation of a radio access node in which at least a portion of the functionality of the radio access node is implemented as a virtual component(s) (e.g., via a virtual machine(s) executing on a physical processing node(s) in a network(s)).

Referring to FIG. 9, the radio access node 204 comprises the control system 700 as described in relation to FIG. 7.

The control system 700 is connected to one or more processing nodes 900 coupled to or included as part of a network(s) 902 via the network interface 706. Each processing node 900 comprises one or more processors 904 (e.g., CPUs, ASICs, FPGAs, and/or the like), memory 906, and a network interface 908.

In this example, functions 910 of the radio access node 204 described herein are implemented at the one or more processing nodes 900 or distributed across the control system 700 (as the function 716) and the one or more processing nodes 900 in any desired manner. In some embodiments, some or all of the functions 910 of radio access node 204 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 700 is used in order to carry out at least some of the desired functions 910. As indicated by dotted lines, in some embodiments the control system 700 may be omitted, in which case the radio unit(s) 708 communicate directly with the processing node(s) 900 via an appropriate network interface(s).

In some embodiments, a computer program comprises instructions which, when executed by at least one processor, causes at least one processor to carry out the functionality of a radio access node 204 or another node (e.g., a processing node 900) implementing one or more of the functions of the radio access node 204 in a virtual environment according to any of the embodiments described herein.

While the disclosed subject matter has been presented above with reference to various embodiments, it will be understood that various changes in form and details may be made to the described embodiments without departing from the overall scope of the disclosed subject matter.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
ASIC Application Specific Integrated Circuit
BD Blind Decoding
BL Bandwidth-Reduced Low-Complexity
CE Coverage Enhancement
CPU Central Processing Unit
DCI Downlink Control Information
eMTC Enhanced Machine Type Communication
eNB Enhanced or Evolved Node B
FeMTC Further Enhancements for Machine Type Communication
FPGA Field Programmable Gate Array
LSB Least-Significant Bit
LTE Long Term Evolution
M2M Machine-to-Machine
MHz Megahertz
MPDCCH Machine Type Communication Physical Downlink Control Channel
MSB Most-Significant Bit
MTC Machine Type Communication
NB-IoT Narrowband Internet of Things
NR New Radio
PDCCH Physical Downlink Control Channel
PDSCH Physical Downlink Shared Channel
PRB Physical Resource Block
PRG Physical Resource Block Group
PUSCH Physical Uplink Shared Channel
RAN Radio Access Network
RAN1 Radio Access Network Radio Layer 1
RBG Resource Block Group
Rel Release
UE User Equipment

Those skilled in the art will recognize improvements and modifications to the embodiments of the present disclosure. All such improvements and modifications are considered within the scope of the concepts disclosed herein.

### REFERENCES

[1] 3GPP TS 36.306 “Evolved Universal Terrestrial Radio Access (E-UTRA); User Equipment (UE) radio access capabilities,” V13.2.0 (2016 June)
[2] 3GPP TS 36.211 “Evolved Universal Terrestrial Radio Access (E-UTRA); Physical channels and modulation,” V13.2.0 (2016 June)
[3] 3GPP TS 36.212 “Evolved Universal Terrestrial Radio Access (E-UTRA); Multiplexing and channel coding,” V13.2.0 (2016 June)
[4] 3GPP TS 36.213 “Evolved Universal Terrestrial Radio Access (E-UTRA); Physical layer procedures,” V13.2.0 (2016 June)
[5] 3GPP Tdoc RP-161464, “Revised WID for Further Enhanced MTC”
[6] R1-1611048, “Summary of RAN1 agreements for Rel-14 FeMTC,” Ericsson

1. A method of operation of a wireless communication device in a wireless communication system, the wireless communication device operating in a wide bandwidth that is larger than a predefined narrowband bandwidth, comprising:
receiving, from a network node, downlink control information comprising a resource block assignment, wherein:
five least-significant bits of the resource block assignment are any one of a set of bit combinations; and
the set of bit combinations consists of: {10101}, {10110}, {10111}, {11000}, {11001}, {11010}, {11011}, {11100}, {11101}, {11110}, and {11111}; and
utilizing the resource block assignment, where utilizing the resource block assignment comprises interpreting the resource block assignment such that the one of the set of bit combinations comprised in the five least-significant bits of the resource block assignment provides a resource allocation within the wide bandwidth.

2. The method of claim 1 wherein the five least-significant bits of the resource block assignment are one of a group consisting of: {10101}, {10110}, and {10111}.

3. The method of claim 1 wherein:
a system bandwidth of the wireless communication system is logically divided into a plurality of narrowband portions;
the wide bandwidth in which the wireless communication device is operating is a subset of the plurality of narrowband portions;
each narrowband portion of the subset of the plurality of narrowband portions within the wide bandwidth is logically divided into two physical resource block groups; and
the resource allocation is a resource allocation for each of the two physical resource block groups in each of the subset of the plurality of narrowband portions within the wide bandwidth.

4. The method of claim 1 wherein interpreting the resource block assignment comprises interpreting the resource block assignment such that a number of most-significant bits of the resource block assignment provide a starting narrowband index for the wide bandwidth.

5. The method of claim 4 wherein:
a system bandwidth of the wireless communication system is logically divided into a plurality of narrowband portions each of the predefined narrowband bandwidth; and
the starting narrowband index indicates one of the plurality of narrowband portions that is a starting narrowband portion for the wide bandwidth in which the wireless communication device is operating.

6. The method of claim 4 wherein the number of most-significant bits interpreted to provide the starting narrowband index for the wide bandwidth is defined as:
$$StartingNarrowbandIndexSize = ⌈ {log}_{2} ⌊ \frac{{N}_{RB}^{DL}}{6} ⌋ ⌉ ,$$
where StartingNarrowbandIndexSize is the number of most-significant bits interpreted to provide the starting narrowband index for the wide bandwidth and N_{RB}^{DL} is the system bandwidth represented as a number of resource blocks.

7. The method of claim 1 wherein the wireless communication system is a Long Term Evolution, LTE, system, and the set of bit combinations is a plurality of bit combinations that are unused for Downlink Control Information, DCI, format 6-A1 type 2 resource allocation.

8. The method of claim 1 wherein each of the set of bit combinations has a predefined mapping to a different resource allocation for the wide bandwidth.

9. (canceled)

10. A wireless communication device for a wireless communication system, the wireless communication device operating in a wide bandwidth that is larger than a predefined narrowband bandwidth and being adapted to:
receive, from a network node, Downlink Control Information, DCI, comprising a resource block assignment, wherein:
five least-significant bits of the resource block assignment are any one of a set of bit combinations; and
the set of bit combinations consists of: {10101}, {10110}, {10111}, {11000}, {11001}, {11010}, {11011}, {11100}, {11101}, {11110}, and {11111}; and
utilize the resource block assignment, where utilizing the resource block assignment comprises interpreting the resource block assignment such that the one of the set of bit combinations comprised in the five least-significant bits of the resource block assignment provides a resource allocation within the wide bandwidth.

11-21. (canceled)

22. A method of operation of a radio access node in a wireless communication system, comprising:
transmitting, to a wireless communication device operating in a wide bandwidth that is larger than a predefined narrowband bandwidth, Downlink Control Information, DCI, comprising a resource block assignment, wherein:
five least-significant bits of the resource block assignment are any one of a set of bit combinations; and
the set of bit combinations consists of: {10101}, {10110}, {10111}, {11000}, {11001}, {11010}, {11011}, {11100}, {11101}, {11110}, and {11111}.

23. The method of claim 22 wherein the five least-significant bits of the resource block assignment are one of a group consisting of: {10101}, {10110}, and {10111}.

24. (canceled)

25. A radio access node for a wireless communication system, the radio access node being adapted to:
transmit, to a wireless communication device operating in a wide bandwidth that is larger than a predefined narrowband bandwidth, Downlink Control Information, DCI, comprising a resource block assignment, wherein:
five least-significant bits of the resource block assignment are any one of a set of bit combinations; and
the set of bit combinations consists of: {10101}, {10110}, {10111}, {11000}, {11001}, {11010}, {11011}, {11100}, {11101}, {11110}, and {11111}.

26. The radio access node of claim 25 wherein the five least-significant bits of the resource block assignment are one of a group consisting of: {10101}, {10110}, and {10111}.

27-29. (canceled)

30. The wireless communication device of claim 10 wherein the five least-significant bits of the resource block assignment are one of a group consisting of: {10101}, {10110}, and {10111}.

31. The wireless communication device of claim 10 wherein:
a system bandwidth of the wireless communication system is logically divided into a plurality of narrowband portions;
the wide bandwidth in which the wireless communication device is operating is a subset of the plurality of narrowband portions;
each narrowband portion of the subset of the plurality of narrowband portions within the wide bandwidth is logically divided into two physical resource block groups; and
the resource allocation is a resource allocation for each of the two physical resource block groups in each of the subset of the plurality of narrowband portions within the wide bandwidth.

32. The wireless communication device of claim 10 wherein interpreting the resource block assignment comprises interpreting the resource block assignment such that a number of most-significant bits of the resource block assignment provide a starting narrowband index for the wide bandwidth.

33. The wireless communication device of claim 32 wherein:
a system bandwidth of the wireless communication system is logically divided into a plurality of narrowband portions each of the predefined narrowband bandwidth; and
the starting narrowband index indicates one of the plurality of narrowband portions that is a starting narrowband portion for the wide bandwidth in which the wireless communication device is operating.

34. The wireless communication device of claim 32 wherein the number of most-significant bits interpreted to provide the starting narrowband index for the wide bandwidth is defined as:
$$StartingNarrowbandIndexSize = ⌈ {log}_{2} ⌊ \frac{{N}_{RB}^{DL}}{6} ⌋ ⌉ ,$$
where StartingNarrowbandIndexSize is the number of most-significant bits interpreted to provide the starting narrowband index for the wide bandwidth and N_{RB}^{DL} is the system bandwidth represented as a number of resource blocks.

35. The wireless communication device of claim 10 wherein the wireless communication system is a Long Term Evolution, LTE, system, and the set of bit combinations is a plurality of bit combinations that are unused for Downlink Control Information, DCI, format 6-A1 type 2 resource allocation.

36. The wireless communication device of claim 10 wherein each of the set of bit combinations has a predefined mapping to a different resource allocation for the wide bandwidth.
